(19) United States
(12) Patent Application Publication
(10) Pub. No.: US 2016/0302642 A1
(43) Pub. Date: Oct. 20, 2016

(54) DISHWASHER APPLIANCES AND METHODS FOR OPERATING SAME

(71) Applicant: General Electric Company, Schenectady, NY (US)

(72) Inventor: Matthew David Mersch, Louisville, KY (US)

(21) Appl. No.: 14/687,047

(22) Filed: Apr. 15, 2015

(51) Int. Cl. A47L 15/42; B08B 3/14

(52) U.S. Cl. CPC A47L 15/4208; B08B 3/14

(57) ABSTRACT

Dishwasher appliances and methods for operating dishwasher appliances are provided. A dishwasher appliance includes a cabinet defining a wash chamber for the receipt of articles for washing, a sump for collection of fluid from the wash chamber, and a filter positioned between the wash chamber and the sump for filtering the fluid from the wash chamber. The dishwasher appliance further includes a fluid circulation system, the fluid circulation system including a lower spray assembly and a second spray assembly disposed above the lower spray assembly along a vertical direction. The fluid circulation system further includes a cleaning spray assembly independent of the lower spray assembly and the second spray assembly, the cleaning spray assembly oriented to emit fluid towards the filter.

### FIELD OF THE INVENTION

The present disclosure relates generally to dishwasher appliances, and more particularly to dedicated cleaning spray assemblies for cleaning filters of dishwasher appliances and methods for operating such dishwasher appliances.

### BACKGROUND OF THE INVENTION

During wash and rinse cycles, dishwasher appliances typically circulate a fluid through the wash chamber and over articles such as pots, pans, silverware, and other cooking utensils. The fluid can be e.g., various combinations of water and detergent during the wash cycle or water (which may include additives) during the rinse cycle. Typically the fluid is recirculated during a given cycle using a pump. Fluid is collected at or near the bottom of the wash chamber and pumped back into the chamber through e.g., nozzles in the spray arms and other openings that direct the fluid against the articles to be cleaned or rinsed.

Depending upon the level of soil upon the articles, the fluid will become contaminated with the soil in the form of debris and particles that are carried with the fluid. In order to protect the pump and make sure the fluid can continue to recirculate through the wash chamber, the fluid is typically filtered during its movement between the wash chamber and the pump so that relatively clean fluid is supplied to the pump inlet. In addition to pump protection, such filtration also helps to clean the articles by removing soil from the fluid. Accordingly, typical dishwashers include a sump for collection of fluid from the dishwasher wash chamber. The sump may be in fluid communication with the pump. Further, a filter, generally known as a coarse filter, may be provided adjacent the sump, to filter the fluid before it is provided to the sump.

One issue during operation of dishwasher appliances is the cleanliness of the filter. As debris collects on or in the filter, it can cause blockages and resulting inefficient operation of the filter. In some dishwasher appliances, apertures in the lower spray arm are thus oriented to emit fluid towards the filter, in order to “clean” the filter and reduce such blockages and inefficient operation. However, recently, dishwasher appliances have been introduced which do not always flow fluid to the lower spray arm. For example, in many currently known dishwasher appliances, fluid flow is selectively flowed to the lower spray arm or the mid-level spray arm and/or upper spray assembly. When fluid is not being flowed to the lower spray arm, no fluid is being emitted from the apertures oriented towards the filter. Accordingly, no cleaning is occurring, and blockages and inefficient operation during these periods of operation of dishwasher appliances can thus result.

Accordingly, improved dishwasher appliances and methods for operating dishwasher appliances are desired. In particular, dishwasher appliances and methods which utilize dedicated spray assemblies for filter cleaning purposes would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a dishwasher appliance is provided. The dishwasher appliance includes a cabinet defining a wash chamber for the receipt of articles for washing, a sump for collection of fluid from the wash chamber, and a filter positioned between the wash chamber and the sump for filtering the fluid from the wash chamber. The dishwasher appliance further includes a fluid circulation system, the fluid circulation system including a lower spray assembly and a second spray assembly disposed above the lower spray assembly along a vertical direction. The fluid circulation system further includes a cleaning spray assembly independent of the lower spray assembly and the second spray assembly, the cleaning spray assembly oriented to emit fluid towards the filter.

In accordance with another embodiment of the present disclosure, a method for operating a dishwasher appliance is provided. The method includes flowing fluid through a pump of the dishwashing appliance, and selectively flowing a first portion of the fluid from the pump to one of a lower spray assembly or a second spray assembly of the dishwasher appliance, the second spray assembly disposed above the lower spray assembly along a vertical direction. The method further includes flowing a second portion of the fluid from the pump through a cleaning spray assembly that is independent of the lower spray assembly and the second spray assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of a dishwasher appliance in accordance with one embodiment of the present disclosure;

FIG. 2 is a cross-sectional view of a dishwasher appliance in accordance with one embodiment of the present disclosure;

FIG. 3 is a perspective view of a sump portion of a dishwasher appliance, including a filter and cleaning spray assemblies positioned within the dishwasher appliance, in accordance with one embodiment of the present disclosure;

FIG. 4 is a cross-sectional view of a portion of a dishwasher appliance, including a filter, a cleaning spray assembly, a diverter assembly and a pump, in accordance with one embodiment of the present disclosure;

FIG. 5 is a cross-sectional view of a diverter in a position wherein fluid is being flowed to a lower spray assembly in accordance with one embodiment of the present disclosure;

FIG. 6 is a cross-sectional view of a diverter in a position wherein fluid is being flowed to a second spray assembly in accordance with one embodiment of the present disclosure;

FIG. 7 is a cross-sectional view of a manifold in accordance with one embodiment of the present disclosure;

FIG. 8 is a cross-sectional view of a diverter in accordance with another embodiment of the present disclosure;

FIG. 9 is a top view of a diverter in accordance with another embodiment of the present disclosure; and

FIG. 10 is a perspective view of a manifold in accordance with another embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to but need not be limited to dishes, pots, pans, silverware, and other cooking utensils and items that can be cleaned in a dishwasher appliance. The term “wash cycle” is intended to refer to one or more periods of time during which a dishwasher appliance operates while containing the articles to be washed and uses a detergent and water, preferably with agitation, to e.g., remove soil particles including food and other undesirable elements from the articles. The term “rinse cycle” is intended to refer to one or more periods of time in which the dishwasher appliance operates to remove residual soil, detergents, and other undesirable elements that were retained by the articles after completion of the wash cycle. The term “fluid” refers to a liquid used for washing and/or rinsing the articles and is typically made up of water that may include other additives such as detergent or other treatments.

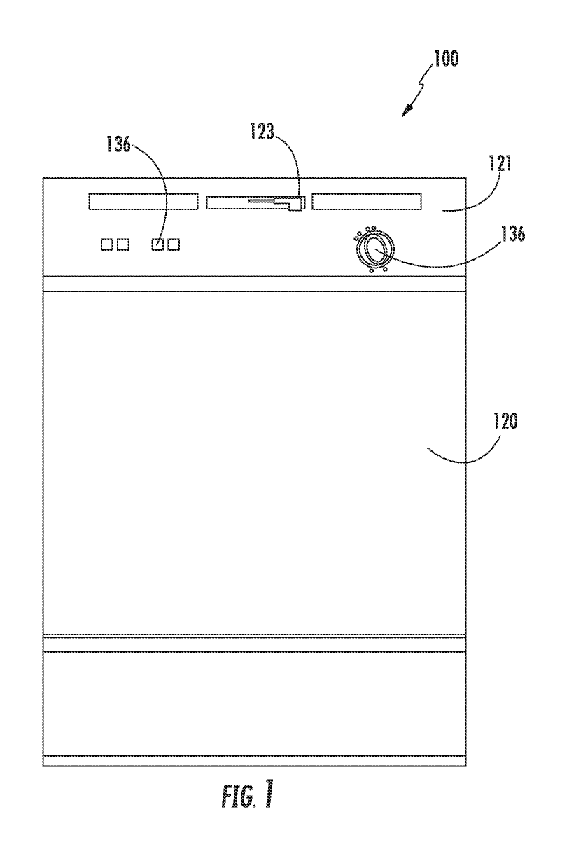

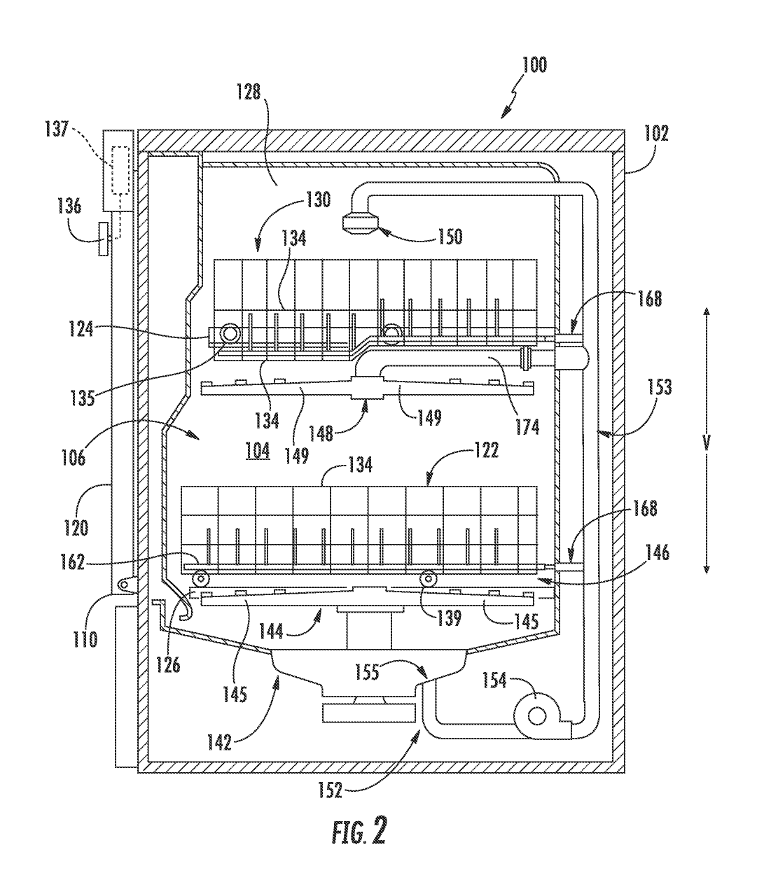

FIGS. 1 and 2 depict an exemplary domestic dishwasher or dishwasher appliance 100 that may be configured in accordance with aspects of the present disclosure. For the particular embodiment of FIGS. 1 and 2, the dishwasher 100 includes a cabinet 102 having a tub 104 therein that defines a wash chamber 106. The tub 104 includes a front opening (not shown) and a door 120 hinged at its bottom 122 for movement between a normally closed vertical position (shown in FIGS. 1 and 2), wherein the wash chamber 106 is sealed shut for washing operation, and a horizontal open position for loading and unloading of articles from the dishwasher. Latch 123 is used to lock and unlock door 120 for access to chamber 106.

Upper and lower guide rails 124, 126 are mounted on tub side walls 128 and accommodate roller-equipped rack assemblies 130 and 132. Each of the rack assemblies 130, 132 is fabricated into lattice structures including a plurality of elongated members 134 (for clarity of illustration, not all elongated members making up assemblies 130 and 132 are shown in FIG. 2). Each rack 130, 132 is adapted for movement between an extended loading position (not shown) in which the rack is substantially positioned outside the wash chamber 106, and a retracted position (shown in FIGS. 1 and 2) in which the rack is located inside the wash chamber 106. This is facilitated by rollers 135 and 139, for example, mounted onto racks 130 and 132, respectively. A silverware basket (not shown) may be removably attached to rack assembly 132 for placement of silverware, utensils, and the like, that are otherwise too small to be accommodated by the racks 130, 132.

The dishwasher 100 further includes a lower spray assembly 144 that is mounted within a lower region 146 of the wash chamber 106 and above a tub sump portion 142 (along a vertical direction V) so as to operate in relatively close proximity to rack assembly 132. A mid-level spray assembly 148 is located in an upper region of the wash chamber 106 and may be located in close proximity to upper rack 130. Additionally, an upper spray assembly 150 may be located above the upper rack 130.

One or more of the spray assemblies may include a plurality of arms and be rotatable about a central axis. For example, as shown, lower spray assembly 144 may be a lower spray-arm assembly having arms 145 and rotatable about a central axis. Mid-level spray assembly 148 may be a mid-level spray arm assembly having arms 149 and rotatable about a central axis. Upper spray assembly 150 is illustrated as stationary with no arms, but may alternatively be an upper spray arm assembly having arms and rotatable about a central axis.

The lower, mid-level and upper spray assemblies 144, 148, 150 are generally components of a fluid circulation system 152, and may be fed by a fluid circulation assembly 153 of the system 152. Fluid circulation assembly 153 generally includes one or more conduits for flowing fluid therethrough and to the various assemblies 144, 148, 150 and other suitable components as discussed herein. The fluid circulation system 152 may further include a pump 154 located in a machinery compartment 140 of the tub 104, as generally recognized in the art. Each spray assembly 144, 148, 150 includes an arrangement of discharge ports or orifices for directing washing liquid onto dishes or other articles located in rack assemblies 130 and 132. When the assemblies are spray arm assemblies, the arrangement of the discharge ports in spray-arm assemblies 144, 148 provides a rotational force by virtue of washing fluid flowing through the discharge ports. The resultant rotation of these spray arm assemblies 144, 148 provides coverage of dishes and other dishwasher contents with a washing spray.

The dishwasher 100 is further equipped with a controller 137 to regulate operation of the dishwasher 100. The controller may include a memory and one or more microprocessors, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 137 may be positioned in a variety of locations throughout dishwasher 100. In the illustrated embodiment, the controller 137 may be located within a control panel area 121 of door 120 as shown. In such an embodiment, input/output (“I/O”) signals may be routed between the control system and various operational components of dishwasher 100 along wiring harnesses that may be routed through the bottom 122 of door 120. Typically, the controller 137 includes a user interface panel 136 through which a user may select various operational features and modes and monitor progress of the dishwasher 100. In one embodiment, the user interface 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller 137 via one or more signal lines or shared communication busses.

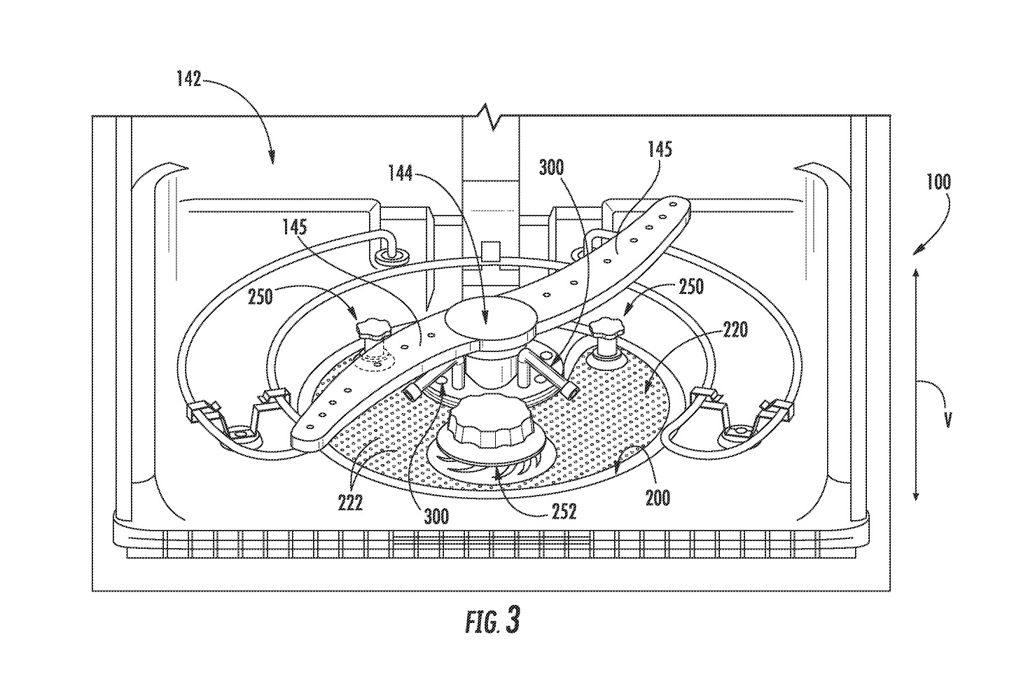

Referring now to FIGS. 3 and 4, various embodiments of sump portion 142 are provided. Sump portion 142 generally collects and filters the fluid, and provides the fluid for recirculation through the wash chamber 106 during operation of the dishwasher. For example, sump portion 142 may include a sump 200. The sump 200 may collect fluid from the wash chamber 106. Sump portion 142 may further include a filter 220. Filter 220 filters the fluid from the wash chamber 106 before it is collected by the sump 200. As shown, for example, filter 220 may be constructed as a grate located in the sump portion 142, and may define a plurality of apertures 222 therein which allow the fluid and particles smaller than apertures 222 to pass through. Filter 220 may further include one or more openings 224, which may be larger than apertures 222. Each opening 224 may be defined in the filter 220 to accommodate therein a vent 250 or secondary filter 252.

Notably, filter 220 is in exemplary embodiments a coarse filter, while filter 252 in exemplary embodiments is a fine filter. Accordingly, apertures 222 are generally larger than apertures (not labeled) of the fine filter 252. Filter 220 may be a generally horizontal, plate-like filter disposed at the bottom of the tub 104 above the sump 200. Filter 252 may be generally vertically-walled filter, having for example a cylindrical shape, which is disposed below the filter 220 and the bottom of the tub 104 in the sump 200 and/or sump portion 142.

Referring to FIG. 4 as well as to FIG. 2, in some embodiments, a sump portion 142 further includes a pump 154. After the fluid is filtered and collected, it is fed to the inlet 155 of pump 154 for return to the wash chamber 106 by way of fluid circulation assembly 152. Accordingly, filter 220 and sump 200 act to clean soil particles from the fluid and protect pump 154 from clogging as the fluid is recirculated during e.g., a wash or rinse cycle of dishwasher 100. Fluid from e.g., spray assemblies 144, 148 and 150 travel over articles in wash chamber 106 and down to sump portion 142 carrying soil particles from the articles. The fluid is filtered by filter 220. The filtered fluid is flowed in the sump 200 to the inlet 155 of pump 154 for recirculation.

Referring now to FIGS. 3 through 9, the present disclosure is further directed to methods and apparatus for providing improved operation of dishwasher appliances, particularly by providing improved cleaning of the filter 220 during appliance 100 operation. To facilitate such improved cleaning, dishwasher appliances 100 and fluid circulation systems 152 thereof may further include one or more cleaning spray assemblies 300. Each cleaning spray assembly 300 may be in fluid communication with other components of the fluid circulation system 152, and may generally emit fluid during operation of the dishwasher appliance 100. In particular, each cleaning spray assembly 300 may be independent of other spray assemblies of the dishwasher appliance 100, and may thus provide a dedicated stream of fluid for cleaning the filter 220. Each cleaning spray assembly 300 may, as shown, be oriented to emit fluid towards the filter 220, such that this fluid contacts the filter 220 and can interact with debris thereon to generally unclog and clean the filter 220 during appliance 100 operation.

Cleaning spray assemblies 300 are independent of other spray assemblies of the dishwasher appliance 100. For example, fluid circulation system 152 may include a lower spray assembly 144 and one or more other spray assemblies. For example, fluid circulation system 152 may include a second spray assembly, and may optionally further include a third spray assembly. In exemplary embodiments, the second spray assembly may be the mid-level spray assembly 148 or the upper spray assembly 150. The third spray assembly may, for example, be the other of the mid-level spray assembly 148 or upper spray assembly 150. The second and third spray assemblies may be disposed above the lower spray assembly 144 in the vertical direction. Cleaning spray assemblies 300 in accordance with the present disclosure are independent of the lower spray assembly 144 and second and third spray assemblies, and thus may be operable to emit fluid independently of operation of the lower spray assembly 144 and second and third spray assemblies to emit fluid.

In exemplary embodiments, a cleaning spray assembly 300 may be disposed below the lower spray assembly 144 along the vertical direction V, such that outlet apertures 302 of the cleaning spray assembly are between the lower spray assembly 144 and the filter 220. Fluid emitted from the cleaning spray assembly 300 through the outlet apertures 302 may be emitted towards the filter 220.

A cleaning spray assembly 300 in accordance with the present disclosure may include a conduit 304 defining a passage 306 therein through which fluid can be flowed. Assembly 300 may further include one or more outlet apertures 302, which may be defined in the conduit 304 or a head 308 connected to an end of the conduit 304. Fluid may flow through the passage 306 and from the passage 306 through the outlet apertures 302 to be emitted from the cleaning spray assembly 300.

Cleaning spray assembly 300 may be in fluid communication with various other components of fluid circulation system 152 to receive fluid therefrom independently of the lower spray assembly 144, second spray assembly, and third spray assembly. For example, in exemplary embodiments, fluid circulation system 152 further includes pump 154, as discussed, and a diverter assembly 320. The diverter assembly 320 may be in fluid communication with the pump 154, and may receive fluid from the pump 154. Diverter assembly 320 may further selectively flow fluid from the pump 154 to the lower spray assembly 144 or second spray assembly and/or third spray assembly. Further, a cleaning spray assembly 300 may be in fluid communication with the diverter assembly 320 to divert a portion of the fluid flow from the diverter assembly 320 for flow through the cleaning spray assembly 300.

A diverter assembly 320 in accordance with the present disclosure generally includes a diverter 322, and may further include a manifold 234. Diverter 322 may be in fluid communication with the pump 154 for receiving fluid from the pump 154, and for selectively flowing the fluid through one of a plurality of outlets thereof. Manifold 234 may be in fluid communication with the diverter 322 for selectively flowing fluid from the diverter 322, such as from an outlet thereof, to one or more of lower spray assembly 144, second spray assembly and third spray assembly. Fluid may be flowed from the pump 154 through the diverter 322, and from the diverter 322 through the manifold 234 to one or more of lower spray assembly 144, second spray assembly and third spray assembly.

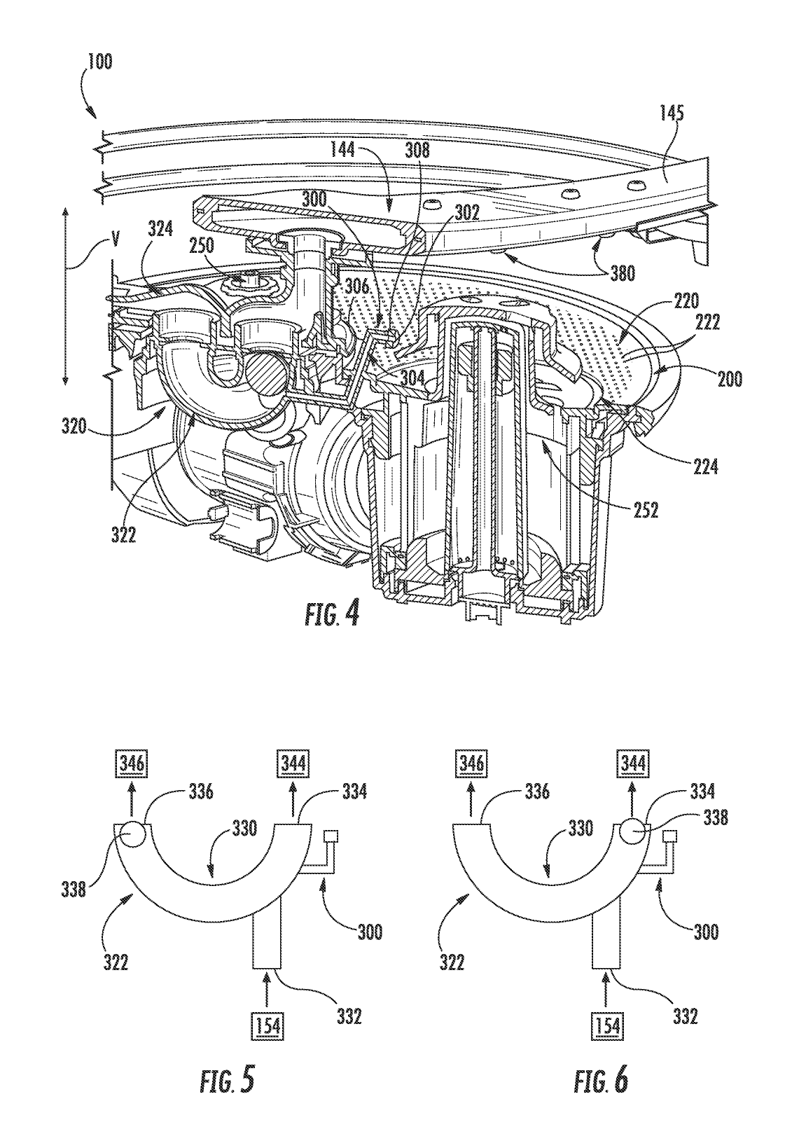

FIGS. 4 through 7 illustrate one embodiment of diverter assembly 320. In this embodiment, diverter 322 includes a conduit assembly 330 having a single inlet 332, a first outlet 334 and a second outlet 336. A ball 338 or other suitable component for selectively blocking fluid flow through one of the outlets 334, 336 is disposed and freely movable within the conduit assembly 330. First outlet 334 may be in fluid communication with the lower spray assembly 144, and second outlet 336 may be in fluid communication with the second and/or third spray assembly. When ball 338 or another suitable component is in the position illustrated in FIG. 5, fluid may be flowed through the first outlet 334 and not through the second outlet 336. When ball 338 or another suitable component is in the position illustrated in FIG. 6, fluid may be flowed through the second outlet 336 and not through the first outlet 334. Accordingly, fluid may be selectively flowed through the diverter 322 to either the lower spray assembly 144 or the second and/or third spray assembly.

Manifold 324 may include a first passage 344 and a second passage 336. First passage 344 may be in fluid communication with and between the first outlet 334 and the lower spray assembly 144, and second passage 346 may be in fluid communication with and between the second outlet 336 and the second and/or third spray assembly. Accordingly, fluid may be selectively flowed from the diverter 322 through the manifold 324 to either the lower spray assembly 144 or the second and/or third spray assembly.

In some embodiments, as shown in FIGS. 5 and 6, a cleaning spray assembly 300 may be in fluid communication with the diverter 322, such as with the conduit assembly 330 thereof. Accordingly, a first portion of the fluid may be selectively flowed to either the lower spray assembly 144 or the second and/or third spray assembly, and a second portion of the fluid may be flowed to the cleaning spray assembly 300. Notably, in these embodiments, the second portion of the fluid may be flowed to the cleaning spray assembly 300 when the first portion of the fluid is being flowed to lower spray assembly 144 and when the first portion of the fluid is being flowed to the second and/or third spray assembly. Accordingly, the cleaning spray assembly 300 in these embodiments is operable to emit fluid during fluid flow to the lower spray assembly 144 and the second spray assembly and/or third spray assembly.

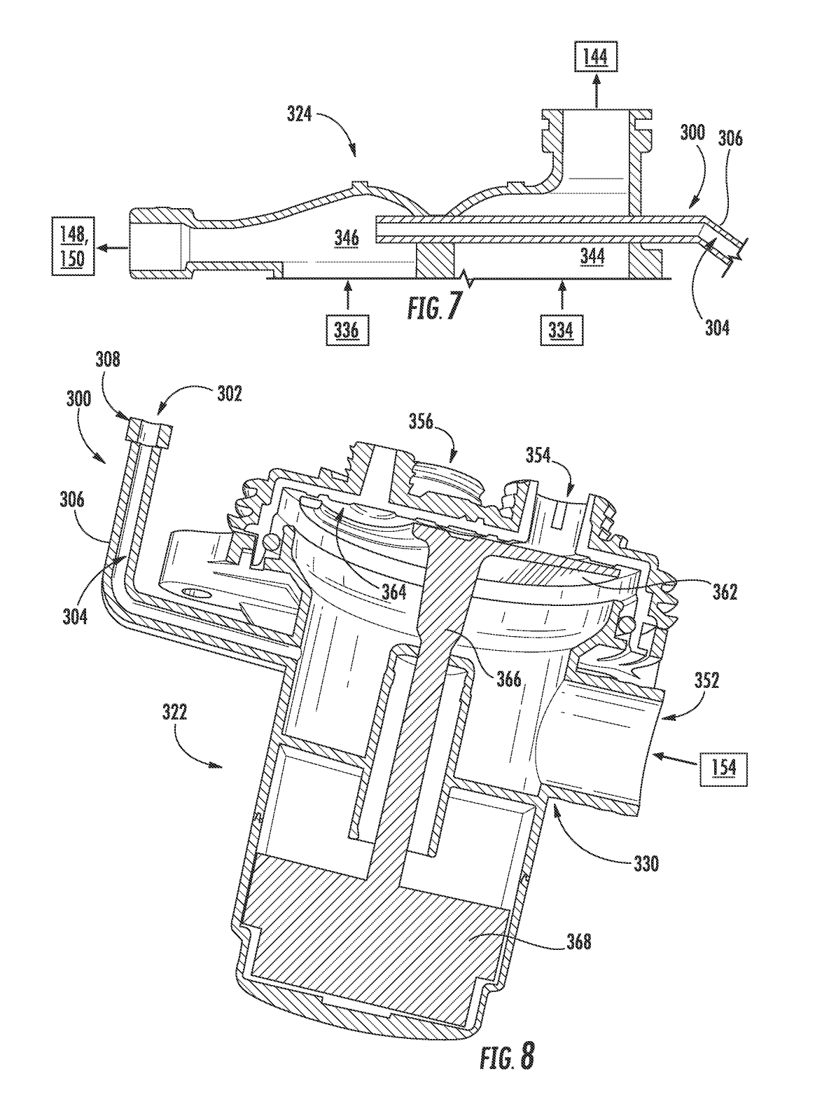

In other embodiments, as shown in FIG. 7, a cleaning spray assembly 300 may be in fluid communication with the manifold 324, such as with the second passage 346 as shown and/or the first passage 344. In the embodiment shown, when a first portion of the fluid is being selectively flowed to the second and/or third spray assembly, a second portion of the fluid may thus be flowed to the cleaning spray assembly 300. Such flow to the cleaning spray assembly 300 may in the embodiment shown not occur when fluid is being selectively flowed to the lower spray assembly 144. Accordingly, the cleaning spray assembly 300 in these embodiments is operable to emit fluid during fluid flow to the second spray assembly and/or third spray assembly, and is not operable to emit fluid during fluid flow to the lower spray assembly 144.

FIGS. 8 through 10 illustrate components of a diverter assembly 320 in accordance with another embodiment of the present disclosure. In this embodiment, diverter 322 may include a conduit assembly 350 having an inlet 352, a first outlet 354 and a second outlet 356, and further optionally having a third outlet 358 and/or a fourth outlet 360. First outlet 354 may be in fluid communication with the lower spray assembly 144, and second outlet 356 may be in fluid communication with the second and/or third spray assembly. Third outlet 358 may additionally be in fluid communication with the lower spray assembly 144, and fourth outlet 360 may additionally be in fluid communication with the second and/or third spray assembly. A plate 362 which defines a selection aperture 364 may be included in the diverter 322, and selective alignment of the plate 362 with any one of the outlets 354, 356, 358, 360 may allow fluid flow through that outlet. A shaft 366 and motor 368 may be connected to the plate 362 and cause rotation of the plate 362 as desired. Accordingly, fluid may be selectively flowed through the diverter 322 to either the lower spray assembly 144 or the second and/or third spray assembly.

Manifold 324 may include a first passage 374 and a second passage 376, as well as an optional third passage 378. First passage 374 may be in fluid communication with and between the first outlet 354 and the lower spray assembly 144, and second passage 376 may be in fluid communication with and between the second outlet 356 and fourth outlet 360 and the second and/or third spray assembly. Third passage 378 may be in fluid communication with and between the third outlet 358 and the lower spray assembly 144. Accordingly, fluid may be selectively flowed from the diverter 322 through the manifold 324 to either the lower spray assembly 144 or the second and/or third spray assembly.

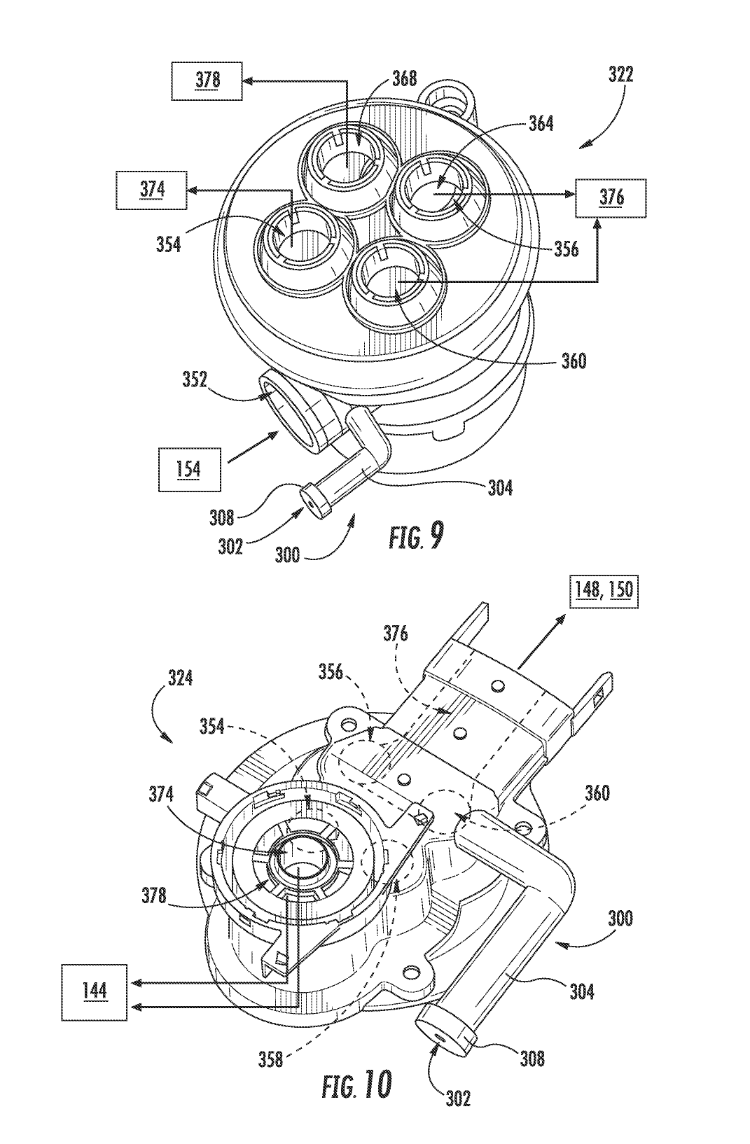

In some embodiments, as shown in FIGS. 8 and 9, a cleaning spray assembly 300 may be in fluid communication with the diverter 322, such as with the conduit assembly 350 thereof. Accordingly, a first portion of the fluid may be selectively flowed to either the lower spray assembly 144 or the second and/or third spray assembly, and a second portion of the fluid may be flowed to the cleaning spray assembly 300. Notably, in these embodiments, the second portion of the fluid may be flowed to the cleaning spray assembly 300 when the first portion of the fluid is being flowed to lower spray assembly 144 and when the first portion of the fluid is being flowed to the second and/or third spray assembly. Accordingly, the cleaning spray assembly 300 in these embodiments is operable to emit fluid during fluid flow to the lower spray assembly 144 and the second spray assembly and/or third spray assembly.

In other embodiments, as shown in FIG. 10, a cleaning spray assembly 300 may be in fluid communication with the manifold 324, such as with the second passage 376 as shown and/or the first passage 374 and/or the third passage 378. In the embodiment shown, when a first portion of the fluid is being selectively flowed to the second and/or third spray assembly, a second portion of the fluid may thus be flowed to the cleaning spray assembly 300. Such flow to the cleaning spray assembly 300 may in the embodiment shown not occur when fluid is being selectively flowed to the lower spray assembly 144. Accordingly, the cleaning spray assembly 300 in these embodiments is operable to emit fluid during fluid flow to the second spray assembly and/or third spray assembly, and is not operable to emit fluid during fluid flow to the lower spray assembly 144.

Notably, in embodiments wherein the cleaning spray assembly 300 is not operable to emit fluid during fluid flow to the lower spray assembly 144, the lower spray assembly 144 may include apertures 380 which are oriented to emit fluid through towards the filter 220. Accordingly cleaning spray assemblies 300 provide fluid to generally clean the filter 220 during fluid flow to the second and/or third spray assembly, and lower spray assembly 144 itself provides fluid to generally clean the filter 220 during fluid flow to the lower spray assembly 144.

The present disclosure is further directed to methods for operating a dishwasher appliance. A method may include, for example, the step of flowing fluid through a pump 154 of the dishwashing appliance 100, as discussed herein. The method may further include, for example, the step of selectively flowing a first portion of the fluid from the pump 154 to one of a lower spray assembly 144 or a second and/or third spray assembly of the dishwasher appliance 100 as discussed herein. The method may further include, for example, the step of flowing a second portion of the fluid from the pump 154 through a cleaning spray assembly 300 that is independent of the lower spray assembly 144 and the second and/or third spray assembly. This second portion may, for example, be emitted from the cleaning spray assembly 300 towards the filter 220 of the dishwasher appliance 100.

In some embodiments, the second portion of the fluid is flowed from the pump 154 through the cleaning spray assembly 300 during flow of the first portion of the fluid from the pump 154 to the lower spray assembly 144 and the second and/or third spray assembly, as discussed herein. In other embodiments, the second portion of the fluid is flowed from the pump 154 through the cleaning spray assembly 300 during flow of the first portion of the fluid from the pump 154 to the second and/or third spray assembly and not flowed from the pump 154 through the cleaning spray assembly 300 during flow of the first portion of the fluid from the pump 154 to the lower spray assembly 144, as discussed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance, comprising:
a cabinet defining a wash chamber for the receipt of articles for washing;
a sump for collection of fluid from the wash chamber;
a filter positioned between the wash chamber and the sump for filtering the fluid from the wash chamber;
a fluid circulation system, the fluid circulation system comprising a lower spray assembly and a second spray assembly disposed above the lower spray assembly along a vertical direction, the fluid circulation system further comprising a cleaning spray assembly independent of the lower spray assembly and the second spray assembly, the cleaning spray assembly oriented to emit fluid towards the filter.

2. The dishwasher appliance of claim 1, wherein the second spray assembly is a mid-level spray assembly.

3. The dishwasher appliance of claim 1, wherein the second spray assembly is an upper spray assembly.

4. The dishwasher appliance of claim 1, wherein the fluid circulation system further comprises a third spray assembly disposed above the lower spray assembly along a vertical direction.

5. The dishwasher appliance of claim 1, wherein the cleaning spray assembly is disposed below the lower spray assembly along the vertical direction.

6. The dishwasher appliance of claim 1, wherein the fluid circulation system further comprises a pump and a diverter assembly in fluid communication with the pump for selectively flowing fluid from the pump to the lower spray assembly or the second spray assembly, and wherein the cleaning spray assembly is in fluid communication with the diverter assembly.

7. The dishwasher appliance of claim 6, wherein the diverter assembly comprises a diverter and a manifold, the diverter in fluid communication with the pump for receiving fluid from the pump, the manifold in fluid communication with the diverter for selectively flowing fluid from the diverter to the lower spray assembly or the second spray assembly.

8. The dishwasher appliance of claim 7, wherein the cleaning spray assembly is in fluid communication with the diverter.

9. The dishwasher appliance of claim 7, wherein the cleaning spray assembly is in fluid communication with the manifold.

10. The dishwasher appliance of claim 1, wherein the cleaning spray assembly is operable to emit fluid during fluid flow to the lower spray assembly and the second spray assembly.

11. The dishwasher appliance of claim 1, wherein the cleaning spray assembly is operable to emit fluid during fluid flow to the second spray assembly and not operable to emit fluid during fluid flow to the lower spray assembly.

12. A method for operating a dishwashing appliance, the method comprising:
flowing fluid through a pump of the dishwashing appliance;
selectively flowing a first portion of the fluid from the pump to one of a lower spray assembly or a second spray assembly of the dishwasher appliance, the second spray assembly disposed above the lower spray assembly along a vertical direction;
flowing a second portion of the fluid from the pump through a cleaning spray assembly that is independent of the lower spray assembly and the second spray assembly.

13. The method of claim 12, wherein the second portion of the fluid is emitted from the cleaning spray assembly towards a filter of the dishwasher appliance.

14. The method of claim 12, wherein the second spray assembly is a mid-level spray assembly.

15. The method of claim 12, wherein the second spray assembly is an upper spray assembly.

16. The method of claim 12, wherein the first portion of the fluid is selectively flowed from the pump to one of the lower spray assembly or a second and third spray assembly, the second and third spray assemblies disposed above the lower spray assembly along the vertical direction.

17. The method of claim 12, wherein the second portion of the fluid is flowed from the pump through the cleaning spray assembly during flow of the first portion of the fluid from the pump to the lower spray assembly and the second spray assembly.

18. The method of claim 12, wherein the second portion of the fluid is flowed from the pump through the cleaning spray assembly during flow of the first portion of the fluid from the pump to the second spray assembly and not flowed from the pump through the cleaning spray assembly during flow of the first portion of the fluid from the pump to the lower spray assembly.

19. The method of claim 12, wherein the cleaning spray assembly is disposed below the lower spray assembly along the vertical direction.
